(19) United States
(12) Patent Application Publication
(10) Pub. No.: US 2021/0136641 A1
(43) Pub. Date: May 6, 2021

(54) Synchronized Handover without Random Access in LEO-NTN

(71) Applicant: MediaTek Singapore Pte. Ltd., Singapore (SG)

(72) Inventors: Abhishek Roy, San Jose, CA (US); Chia-Chun Hsu, Hsin-Chu (TW)

(21) Appl. No.: 17/034,664

(22) Filed: Sep. 28, 2020

Related U.S. Application Data
(60) Provisional application No. 62/930,708, filed on Nov. 5, 2019.

(51) Int. Cl. H04W 36/08; H04W 56/00

(52) U.S. Cl. CPC H04W 36/08; H04W 84/06; H04W 56/0015

(57) ABSTRACT

This innovation describes methods for a New Radio (NR)-based, LEO Non-Terrestrial Networks (NTN) to improve handover (HO) process. As a user equipment (UE) reaches the HO region, the source and target beam-spots (satellite cells) communicate to finalize handover decision and time of handover. LEO satellites use ISL links to make the source and target cells time synchronized. After the HO decision is finalized, the source beam-spot includes this HO time in the HO Command message. Alternatively, the UE can use its location information to autonomously estimates the HO time, associated with handover events, depending on the beam diameter and speed of the LEO satellite. Under the improved handover process, HO in LEO-TNT is configured and performed without the UE explicitly performing a random access (RA) in the target cell, reducing the frequent random-access process.

### CROSS REFERENCE TO RELATED APPLICATIONS

This application claims priority under 35 U.S.C. § 119 from U.S. Provisional Application No. 62/930,708, entitled “Synchronized Handover without Random Access in LEO NTN,” filed on Nov. 5, 2019, the subject matter of which is incorporated herein by reference.

### TECHNICAL FIELD

The disclosed embodiments relate generally to wireless network communications, and, more particularly, to synchronized handover without random access in New-Radio NR-based, LEO Non-Terrestrial Networks (NTNs).

### BACKGROUND

There is increasing interest and participation in 3GPP from the satellite communication industry, with companies and organizations convinced of the market potential for an integrated satellite and terrestrial network infrastructure in the context of 3GPP 5G. Satellites refer to Spaceborne vehicles in Low Earth Orbits (LEO), Medium Earth Orbits (MEO), Geostationary Earth Orbit (GEO) or in Highly Elliptical Orbits (HEO). 5G standards make Non-Terrestrial Networks (NTN)—including satellite segments—a recognized part of 3GPP 5G connectivity infrastructure. A low Earth orbit is an Earth-centered orbit with an altitude of 2,000 km or less, or with at least 11.25 periods per day and an eccentricity less than 0.25. Most of the manmade objects in outer space are in LEO. Low Earth Orbit (LEO) satellites orbit around the earth at a high speed (mobility), but over a predictable or deterministic orbit.

In 4G Long-Term Evolution (LTE) and 5G new radio (NR) networks, an evolved universal terrestrial radio access network (E-UTRAN) includes a plurality of base stations, e.g., evolved Node-Bs (eNodeBs) communicating with a plurality of mobile stations referred as user equipment (UEs). In 5G New Radio (NR), the base stations are also referred to as gNodeBs or gNBs. For UEs in RRC Idle mode mobility, cell selection is the procedure through which a UE picks up a specific cell for initial registration after power on, and cell reselection is the mechanism to change cell after UE is camped on a cell and stays in idle mode. For UEs in RRC Connected mode mobility, handover is the procedure through which a UE hands over an ongoing session from the source gNB to a neighboring target gNB.

Mobility in LEO satellite-based NTN can be quite different from terrestrial networks. In terrestrial networks, cells are fixed but UEs may move in different trajectories. On the other hand, in NTN, most of the LEO satellites travel at some speed relative to the earth's ground, while the UE movements are relatively slow and negligible. For LEO satellites, the cells are moving over time, albeit in a predictable manner. Hence, LEO satellites can estimate the target cell based on its own movement speed, direction and height from the ground, instead of relying on UE's measurement reports. Once the LEO satellite moves to a new cell, most (if not all) of the UEs will be handed over to the same target cell. The network can estimate UEs' locations by using Global Navigation Satellite System (GNSS) or by capturing location information from the core networks.

Handover process in NR-based LEO-NTN involve frequent, periodic handover messages. Naturally, UE's measurement-report (MR) based traditional handover will incur frequent, heavy signaling overhead as the network needs to process MR, trigger HO decision and continue HO signaling in every few seconds. Hence, handover process in NR-NTN needs further improvement to reduce these frequent, periodic handover events and the associated handover signaling load.

### SUMMARY

Low Earth Orbit (LEO) satellites orbit around the earth at a high speed (mobility), but over a predictable or deterministic orbit. This innovation describes methods for a New Radio (NR)-based, LEO Non-Terrestrial Networks (NTN) to improve handover (HO) process. As a user equipment (UE) reaches the HO region, depending on UE's measurement report (MR), the source and target beam-spots (satellite cells) communicate to finalize handover decision and time of handover, represented by the corresponding System Frame Number (SFN). LEO satellites use ISL links to make the source and target cells time synchronized. After the HO decision is finalized, the source beam-spot (satellite cell) includes this handover time in the HO Command message. Alternatively, the UE can use its location information by using Global Navigation Satellite System (GNSS) capability and satellite ephemeris or estimated Position, Velocity and Time (PVT) to autonomously estimates the HO time, associated with handover events, depending on the beam diameter and speed of the LEO satellite. Under the improved handover process, HO in LEO-TNT is configured and performed without the UE explicitly performing a random access (RA) in the target cell, reducing the frequent random-access process.

In one embodiment, a UE establishes a radio resource control (RRC) connection in a source cell served by a source base station in a new radio (NR) based Low Earth Orbit (LEO) Non-Terrestrial Network (NTN). The UE receives a handover command from the source base station via an RRC connection reconfiguration message. The UE determines a timing advance of a target cell from a handover time for synchronization in the target cell served by a target base station. The handover time is represented by an SFN of the target cell. The UE transmits an RRC connection reconfiguration complete message to the target base station and performing a synchronized handover to the target cell without performing an explicit random-access procedure with the target base station.

In another embodiment, a source base station establishes a radio resource control (RRC) connection with a user equipment (UE) in a source cell served by the source gNB in a new radio (NR) based Low Earth Orbit (LEO) Non-Terrestrial Network (NTN). The source gNB receives measurement reports from the UE and thereby determining a handover decision. The source gNB estimates a handover time for the UE to perform a synchronized handover to a target cell served by a target base station. The source gNB transmits a handover command from the source base station to the UE via an RRC connection reconfiguration message. The handover command comprises the handover time represented by a system frame number (SFN) of the target cell.

Other embodiments and advantages are described in the detailed description below. This summary does not purport to define the invention. The invention is defined by the claims.

### BRIEF DESCRIPTION OF THE DRAWINGS

FIG. 1 illustrates an exemplary 5G new radio NR (NR) wireless communication system that supports efficient handover procedure in Low Earth Orbit (LEO) Non-Terrestrial Network (NTN) in accordance with a novel aspect.

FIG. 2 is a simplified block diagram of a wireless transmitting device and a receiving device in accordance with embodiments of the present invention.

FIG. 3 illustrates a Non-Terrestrial Network (NTN) architecture connecting to a 5G core (5GC) with transparent payload in accordance with one novel aspect.

FIG. 4 illustrates a sequence flow of a handover procedure between a UE and source and target base stations (gNBs) without explicit Random-Access procedure in NR LEO-NTN to reduce signaling overhead.

FIG. 5 illustrates embodiments of obtaining handover time T during HO procedure in NR LEO-NTN in accordance with one novel aspect.

FIG. 6 is flow chart of a method of performing synchronized handover from UE perspective in 5G NR-based LEO-NTN in accordance with one novel aspect.

FIG. 7 is flow chart of a method of performing synchronized handover from BS perspective in 5G NR-based LEO-NTN in accordance with one novel aspect.

### DETAILED DESCRIPTION

Reference will now be made in detail to some embodiments of the invention, examples of which are illustrated in the accompanying drawings.

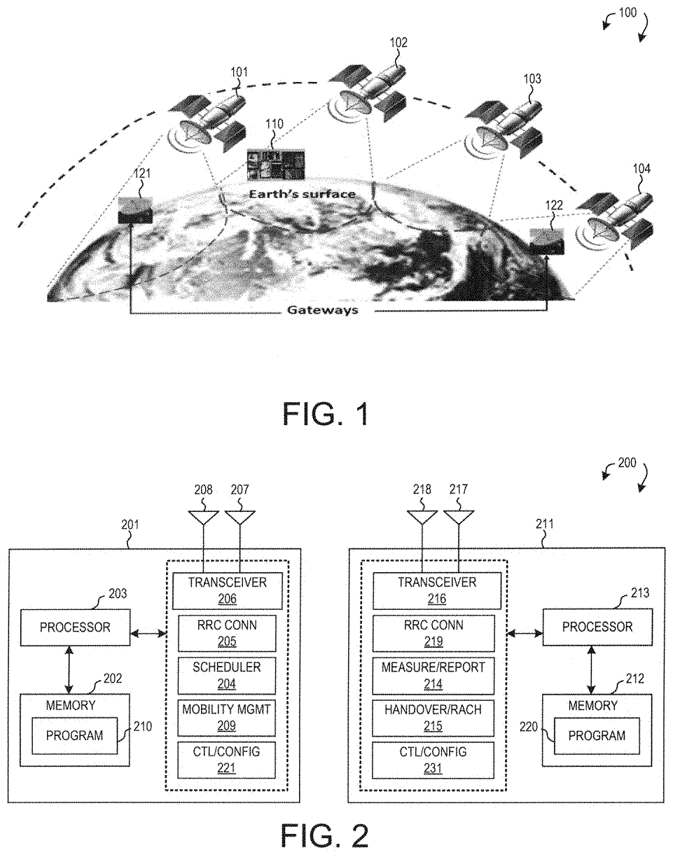

FIG. 1 illustrates an exemplary 5G new radio NR(NR) wireless communication system 100 that supports efficient handover procedure in Low Earth Orbit (LEO) Non-Terrestrial Network (NTN) in accordance with a novel aspect. NR wireless communication system 100 comprises a plurality of base stations gNBs 101-104, a plurality of user equipments (UEs) 110, and a plurality of gateways 121-122. In the example of FIG. 1, the base stations gNBs 101-104 are LEO satellites orbit around the earth at a high speed (mobility), but over a predictable or deterministic orbit. In the example of FIG. 1, the plurality of UEs is initially served in a source cell by LEO satellite gNB 101. Once the LEO satellite moves to a new cell, most of the UEs will be handed over to a new target cell, e.g., served by LEO satellite gNB 102.

Mobility in LEO satellite-based NTN can be quite different from terrestrial networks. In terrestrial networks, cells are fixed but UEs may move in different trajectories. On the other hand, in NTN, most of the LEO satellites travel at some speed relative to the earth's ground, while the UE movements are relatively slow and negligible. For LEO satellites, the cells are moving over time, albeit in a predictable manner. Hence, LEO satellites can estimate the target cell based on its own movement speed, direction and height from the ground, instead of relying on UE's measurement reports. Once the LEO satellite moves to a new cell, most (if not all) of the UEs will be handed over to the same target cell. The network can estimate UEs' locations by using Global Navigation Satellite System (GNSS) or by capturing location information from the core networks.

As the cells are continuously moving at a high speed, many UEs will be frequently handed over from the original source cell to a new target cell. Handover (HO) process in NR-based LEO-NTN involves frequent, periodic handover messages. Naturally, UE's measurement-report (MR) based traditional handover will incur frequent, heavy signaling overhead as the network needs to process MR, trigger HO decision and continue HO signaling in every few seconds. Hence, handover process in NR-NTN need further improvement to reduce these frequent, periodic handover events and the associated handover signaling load. In this invention, an efficient mechanism to configure and perform handover process in LEO-NTN without UE explicitly performing any random-access (RA) in the target beam-spot (cell) is proposed. The improved HO process will help in reducing the frequent random-access process, involved with frequent handover events.

In the example of FIG. 1, as UE 110 reaches the HO region, depending on UE's measurement report (MR), the source and target beam-spots (satellite cells served by gNB 101 and gNB 102) communicate to finalize handover decision and time of handover T, represented by the corresponding System Frame Number (SFN). LEO satellites use ISL links to make the source and target cells time synchronized. The handover time T is typically represented in terms of System Frame Number (SFN). After the HO decision is finalized, the source beam-spot (satellite cell served by gNB 101) includes this handover time T in the HO Command message to UE 110. In another embodiment, UE 110 can also estimate this handover time T by estimating information about its own locations and satellite's speed, direction and beam-spot (cell) sizes by using Global Navigation Satellite System (GNSS) capability and satellite ephemeris data or estimated Position, Velocity and Time (PVT). In one example, UE 110 can use this HO time T to estimate the timing advance (TA) in the target beam spot (satellite cell served by gNB 102), by measuring the propagation delay difference in the signals, received from the source and the target cells. The TA in the target cell is calculated using the difference of HO time T received by the UE from the source cell and target cell.

FIG. 2 is a simplified block diagram of wireless devices 201 and 211 in accordance with embodiments of the present invention. For wireless device 201 (e.g., a base station), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a user equipment), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a base station that includes an RRC connection handling module 205, a scheduler 204, a mobility management module 209, and a control and configuration circuit 221. Wireless device 211 is a UE that includes a measurement module 219, a measurement reporting module 214, a handover handling module 215, and a control and configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow base station 201 and user equipment 211 to perform embodiments of the present invention.

In one example, the base station 201 establishes an RRC connection with the UE 211 via RRC connection handling circuit 205, schedules downlink and uplink transmission for UEs via scheduler 204, performs mobility and handover management via mobility management module 209, and provides measurement and reporting configuration information to UEs via configuration circuit 221. The UE 211 handles RRC connection via RRC connection handling circuit 219, performs measurements and reports measurement results via measurement and reporting module 214, performs RACH procedure and handover via RACH/handover handling module 215, and obtains measurement and reporting configuration information via control and configuration circuit 231. In accordance with one novel aspect, base station 201 uses ISL links to make the source and target cells time synchronized and includes the HO time T in the HO command message. Alternatively, UE 211 autonomously estimate the HO time depending on its own location, beam-spot diameter, and speed of the LEO satellite. Upon receiving the HO command message, UE 211 performs a synchronized handover to the target cell without explicitly performing a random-access procedure to reduce signaling overhead.

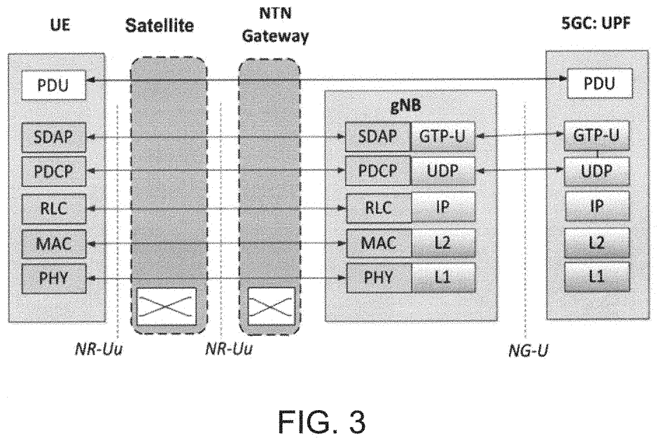

FIG. 3 illustrates a Non-Terrestrial Network (NTN) architecture connecting to a 5G core (5GC) with transparent payload in accordance with one novel aspect. A Non-Terrestrial Network (NTN) refers to a network or a segment of networks using RF resources on board a satellite (or UAS platform). As depicted in FIG. 3, the NTN architecture supports transparent payload between the UE, the gNB, and the 5GC User Plane Function (UPF). For each established PDU session, the UE is connected to the 5GC through its serving gNB over each protocol layer including SDAP, PDCP, RLC, MAC, and PHY. In LEO scenario with LEO orbit at 600 km height and beam spot diameter of around 70 km, there will be frequent handover at less than every 10 s. The satellite speed V=7.5622 km/s, and the beam sport diameter D/V<=10 seconds (=70 km/7.56 km/s). Frequent handover (Beam switching) of all UEs may result in significant service degradation. The solution is to explore synchronized handover without any Random Access (RA) to reduce HO signalling load and make the HO process fast and efficient.

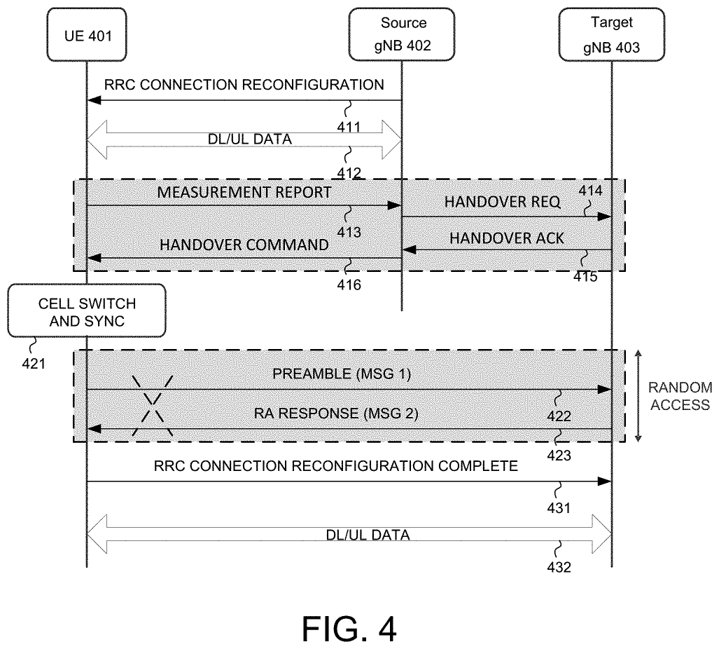

FIG. 4 illustrates a sequence flow of a handover procedure between a UE 401 and source base station gNB 402 and a target base station gNB 403 without explicit Random-Access procedure in NR LEO-NTN to reduce signaling overhead. In step 411, UE 401 is in RRC connected mode and receives RRC connection reconfiguration message from its serving base station gNB 402. In step 412, UE 401 performs DL data reception and UL transmission. In NR-based LEO-NTN, UEs periodically reaches handover region. The measurement report (MR)-based traditional handover will incur frequent and heavy signaling overhead, because the network needs to process the MRs and then trigger handover decision, and continue HO signaling in every few seconds. Excessive MRs are sent from UEs to their serving base station, which processes the MRs and then makes HO decision. For example, in step 413, a plurality of UEs including UE 401 sends MR to source gNB 402. In step 414, source gNB 402 sends a handover request to target gNB 403. In step 415, target gNB 403 sends a handover ACK back to source gNB 402. In step 416, source gNB 402 sends HO commands to each of the UEs including UE 401 which creates excessive signaling overhead. In step 421, UE 401 performs cell switching, e.g., initiates a random-access channel (RACH) procedure in step 422 by sending a RACH preamble (MSG 1) to the target base station gNB 403. When UEs receive the HO commands at the same time, it is likely that UEs will send too many RACH preambles at the same time, generating a “Random Access storm”, and causing RACH collisions. In step 423, instead of successfully receiving a RA Response (MSG 2), the UEs may incur possible HO failure or long HO delay.

Based on the challenges described in FIG. 4, handover process in NR LEO-NTN thus needs further improvements to reduce these frequent, periodic handover events and the associated handover signaling overhead. Connected mode mobility and handover in LEO-satellite based NTN can be characterized by the distinct characteristics, mentioned below: 1) In NTN, UE and network can estimate the location information of the UEs by using GNSS based positioning (for GNSS-enabled UEs); 2) Due to predictable mobility patterns of satellites, LEO-NTN can estimate the satellites locations over time; 3) UE can also estimate the satellite's movement using the PVT information in GNSS; 4) Based on the UEs' locations and movement of satellite cells, LEO-NTN can group the UEs which are located in relatively close proximity, e.g., UEs are located within a predefined distance from each other. Thus, based on the above-mentioned characteristics, connected mode mobility in NTN can be improved.

In a first embodiment, depending on UE's measurement report, the source and target beam-spots (NTN-cells) communicate to finalize handover decision and time of handover (T), represented by the corresponding System Frame Number (SFN). LEO satellites use ISL links to make the source and target cells time synchronized. The source beam-spot (cell) includes this handover time (T) in the RRC Connection Reconfiguration (HO Command) message. In a second embodiment, alternatively, the UE autonomously estimates the HO time (T), associated with subsequent handover events, depending on its own location, beam-spot diameter and speed of the LEO satellite. UE 401 can achieve synchronization with the target cell by calculating the timing advance of the target cell based on the HO time T. With this synchronization, UE 401 reduces the HO interruption time by performing cell switching and synchronization in step 421, and completes the synchronized handover by directly transmitting RRC Connection Reconfiguration Complete (HO Complete) message in step 431, without explicitly performing Random Access (e.g., without exchanging RACH preamble and RA Response messages in step 422 and step 423). In step 432, upon successful handover, UE 401 continues to perform DL data reception and UL transmission with the target gNB 403.

As LEO satellite's speed, direction and beam-sizes are quite deterministic, frequency of HO and the value of HO time (T) is also deterministic. Thus, the value timing advance in target beam (TA_{TGT}) is also quite deterministic. As a result, UE 401 can repeat the above-mentioned steps at a regular periodic interval τ, estimated by using beam coverage and speed of the LEO satellites. Alternatively, the LEO-NTN and UEs can use a two-step CFRA or CBRA by combining the RA with HO signaling, thereby obtaining the same latency as RA-less synchronization. In two-step RA, the UE will send the RA preamble (MSG 1 in step 422) and RRC Connection Reconfiguration Complete (HO Complete) message (in step 431) simultaneously, thereby making the latency associated similar to RA-less handover. The network will receive both RACH preamble and RRC Connection Reconfiguration Complete messages simultaneously. The network will first decode the preamble and if the decoding is successful, it will process the RRC Connection Reconfiguration Complete message as well.

Furthermore, the above-mentioned synchronized HO process can be performed based on some pre-defined and preconfigured conditions, thus making a Conditional HO without any explicit Random Access. In one example, the said measurement condition is based on the following: the signal strength of a neighbor cell is higher than the serving cell signal strength, considering also optional offset and hysteresis additions. UE 401 can also receive multiple Conditional HO (RRC Configurations), each for specific neighbor PCIs and a specific measurement condition. The Conditional HO (RRC Reconfiguration) is one or more of the following: i) Handover Command, ii) SCell addition, iii) SCell removal, iv) SCell PCell role switch (similar to HO command), v) SCG addition, vi) SCG removal, vii) SCG MCG role switch (similar to HO command).

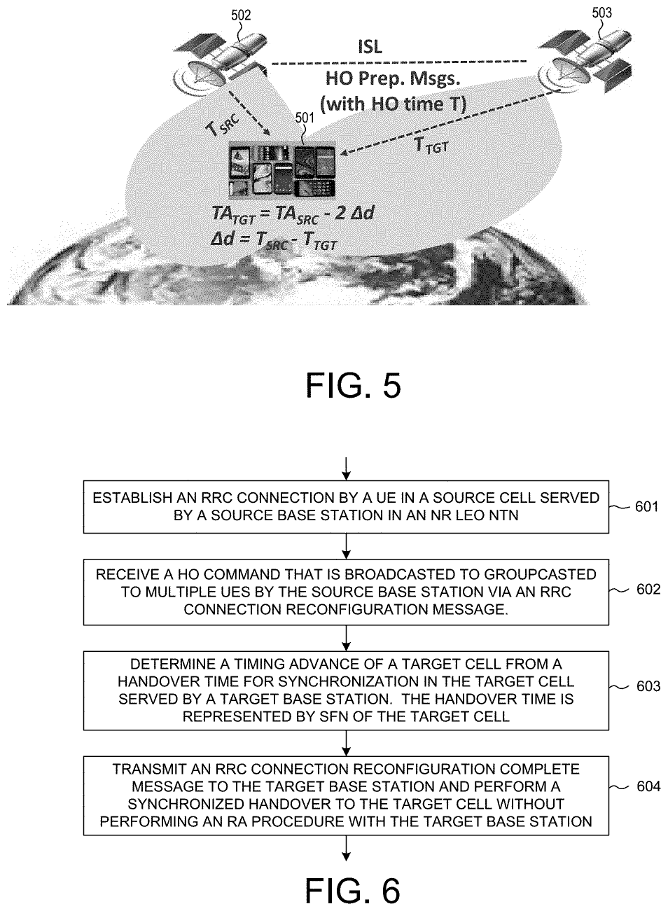

FIG. 5 illustrates embodiments of obtaining handover time T during HO procedure in NR LEO-NTN in accordance with one novel aspect. In the example of FIG. 5, UE 501 is originally served by the source gNB 502, and then handovers to the target gNB 503 upon receiving a handover command from gNB 502. In one embodiment, UE 501 receives handover time T (e.g., T is represented by the SFN of the corresponding cell) carried in the HO command. In another embodiment, UE 501 estimates the handover time T based on its location, beam-spot diameter and speed of the LEO satellite. Upon obtaining the handover time T, the timing advance (TA) of the target cell TA_{TGT} can then be calculated by the UE to achieve synchronization in the target cell. Note that Timing Advance is a MAC CE that is used to control Uplink signal transmission timing. Network (gNB in 5G NR) keeps measuring the time difference between PUSCH/PUCCH/SRS reception and the subframe time and can send a ‘Timing Advance’ command to UE to change the PUSCH/PUCCH transmission to make it better aligned with the subframe timing at the network side. If PUSCH/PUCCH/SRS arrives at the network too early, network can send a Timing Advance command to instructing the UE to “Transmit your signal a little bit later”. If PUSCH/PUCCH/SRS arrives at the network too late, network can send a Timing Advance command to instructing the UE to “Transmit your signal a little bit earlier”.

The timing advance (TA) of the target cell TA_{TGT} can be calculated using the difference of HO time T between the source cell and the target cell. Therefore, UE 501 can estimate the timing advance TA_{TGT} in the target beam-spot (cell), by measuring the propagation delay difference (Δd) in the reference signals received from the source and target cells. UE 501 determines the propagation delay associated with the reference signals (RS) received from source (T_{SRC}) and target (T_{TGT}), by using satellite ephemeris data and as well as GNSS position, PVT or any other similar solution.

TA_{TGT}=TA_{SRC}−2*Δd,

Δd=T_{SRC}−T_{TGT},

### Where

T is represented using System Frame Number (SFN).
T_{SRC} is the SFN when RS received from the source cell.
T_{TGT} is the SFN when RS received from the target cell.
Δd is the propagation delay difference between the source cell and the target cell.
TA_{SRC} is the timing advance of the source cell.
TA_{TGT} is the timing advance of the target cell.

FIG. 6 is flow chart of a method of performing synchronized handover from UE perspective in 5G NR-based LEO-NTN in accordance with one novel aspect. In step 601, a UE establishes a radio resource control (RRC) connection in a source cell served by a source base station in a new radio (NR) based Low Earth Orbit (LEO) Non-Terrestrial Network (NTN). In step 602, the UE receives a handover command from the source base station via an RRC connection reconfiguration message. In step 603, the UE determines a timing advance of a target cell from a handover time for synchronization in the target cell served by a target base station. The handover time is represented by an SFN of the target cell. In step 604, the UE transmits an RRC connection reconfiguration complete message to the target base station and performing a synchronized handover to the target cell without performing an explicit random-access procedure with the target base station.

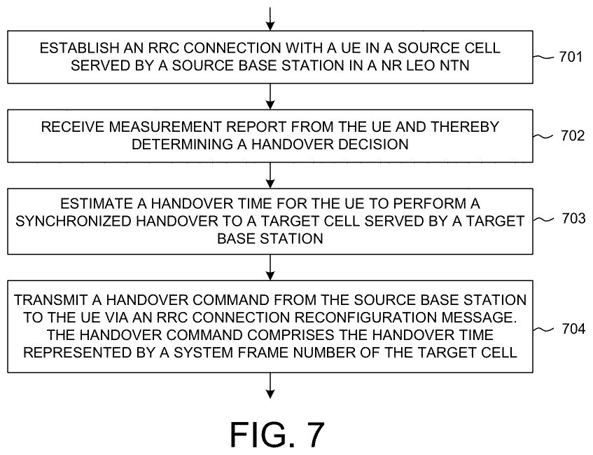

FIG. 7 is flow chart of a method of performing synchronized handover from gNB perspective in 5G NR-based LEO-NTN in accordance with one novel aspect. In step 701, a source base station establishes a radio resource control (RRC) connection with a user equipment (UE) in a source cell served by the source gNB in a new radio (NR) based Low Earth Orbit (LEO) Non-Terrestrial Network (NTN). In step 702, the source gNB receives measurement reports from the UE and thereby determining a handover decision. In step 703, the source gNB estimates a handover time for the UE to perform a synchronized handover to a target cell served by a target base station. In step 704, the source gNB transmits a handover command from the source base station to the UE via an RRC connection reconfiguration message. The handover command comprises the handover time represented by a system frame number (SFN) of the target cell.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing a radio resource control (RRC) connection by a user equipment (UE) in a source cell served by a source base station in a new radio (NR) based Low Earth Orbit (LEO) Non-Terrestrial Network (NTN);
receiving a handover command from the source base station via an RRC connection reconfiguration message;
determining a timing advance of a target cell from a handover time for synchronization in the target cell served by a target base station, wherein the handover time is represented by a system frame number (SFN) of the target cell; and
transmitting an RRC connection reconfiguration complete message to the target base station and performing a synchronized handover to the target cell without performing a random-access procedure with the target base station.

2. The method of claim 1, wherein the UE receives the handover time carried in the handover command for determining the timing advance.

3. The method of claim 1, wherein the UE autonomously estimates the handover time associated with handover events for determining the timing advance.

4. The method of claim 3, wherein the UE estimates the handover time using a UE location, a beam-spot diameter, and a speed of LEO satellites.

5. The method of claim 1, wherein UE estimates the timing advance of the target cell by measuring a propagation delay difference in reference signals received from the source cell and the target cell.

6. The method of claim 5, wherein the UE determines the propagation delay by using at least one of a satellite ephemeris data, Global Navigation Satellite System (GNSS) position, and Position, Velocity, and Time (PVT).

7. The method of claim 1, wherein the UE performs the synchronized handover upon satisfying one or more predefined or preconfigured conditions.

8. The method of claim 7, wherein the predefined or preconfigured conditions comprises a signal strength of a neighbor cell is higher than the serving cell signal strength.

9. A User Equipment (UE), comprising:
a connection handling module that establishes a radio resource control (RRC) connection in a source cell served by a source base station in a new radio (NR) based Low Earth Orbit (LEO) Non-Terrestrial Network (NTN);
a receiver that receives a handover command from the source base station via an RRC connection reconfiguration message;
a synchronization module that determines a timing advance of a target cell for synchronization in the target cell served by a target base station; and
a transmitter that transmits an RRC connection reconfiguration complete message to the target base station and performing a synchronized handover to the target cell without performing a random-access procedure with the target base station.

10. The UE of claim 9, wherein the UE receives a handover time carried in the handover command via the RRC connection reconfiguration message for determining the timing advance.

11. The UE of claim 9, wherein the UE autonomously estimates a handover time associated with handover events for determining the timing advance.

12. The UE of claim 11, wherein the UE estimates the handover time using a UE location, a beam-spot diameter, and a speed of LEO satellites.

13. The UE of claim 9, wherein UE estimates the timing advance of the target cell by measuring a propagation delay difference in reference signals received from the source cell and the target cell.

14. The UE of claim 13, wherein the UE determines the propagation delay by using at least one of a satellite ephemeris data, Global Navigation Satellite System (GNSS) position, and Position, Velocity, and Time (PVT).

15. The UE of claim 9, wherein the UE performs the synchronized handover upon satisfying one or more predefined or preconfigured conditions.

16. The UE of claim 15, wherein the predefined or preconfigured conditions comprises a signal strength of a neighbor cell is higher than the serving cell signal strength.

17. A method comprising:
establishing a radio resource control (RRC) connection with a user equipment (UE) in a source cell served by a source base station in a new radio (NR) based Low Earth Orbit (LEO) Non-Terrestrial Network (NTN);
receiving measurement reports from the UE and thereby determining a handover decision;
estimating a handover time for the UE to perform a synchronized handover to a target cell served by a target base station; and
transmitting a handover command from the source base station to the UE via an RRC connection reconfiguration message, wherein the handover command comprises the handover time represented by a system frame number (SFN) of the target cell.

18. The method of claim 17, wherein the source base station communicates with the target base station to finalize the handover time using Inter-Satellite (ISL) links.

19. The method of claim 17, wherein synchronized handover is performed upon satisfying one or more predefined or preconfigured conditions.

20. The method of claim 19, wherein the predefined or preconfigured conditions comprises a signal strength of a neighbor cell is higher than the serving cell signal strength.
